(19) United States
(12) Patent Application Publication
(10) Pub. No.: US 2015/0255006 A1
(43) Pub. Date: Sep. 10, 2015

(54) Photovoltaics Teaching Aid

(71) Applicant: Matthew Kibbe, Wilbraham, MA (US)

(72) Inventor: Matthew Kibbe, Wilbraham, MA (US)

(21) Appl. No.: 14/640,985

(22) Filed: Mar. 6, 2015

Related U.S. Application Data
(60) Provisional application No. 61/948,803, filed on Mar. 6, 2014.

(51) Int. Cl. G09B 23/40; H02S 10/40; H01M 10/46; H02S 40/44

(52) U.S. Cl. CPC G09B 23/40; H02S 40/44; H02S 10/40; H01M 10/465

(57) ABSTRACT

A photovoltaics teaching aid. The present device is adapted to serve as a teaching aid in order to assist individuals in learning the principles behind photovoltaics, in order to better promote science, technology, engineering, and mathematics (STEM) education. The present invention is a transportable cart including an angled, adjustable array of solar panels, a rechargeable battery, and a solar water heating system. The present invention further includes a number of different devices that are removably attached to the cart to assist individuals in making necessary measurements for calculations, including a multimeter and an angle gauge. Furthermore, a bus is provided that allows individuals to alternatively connect the panels of the solar array in series or in parallel. By changing the manner by which the panels are connected, individuals can study the different resulting effects on the other electrical components.

### CROSS REFERENCE TO RELATED APPLICATION

This application claims the benefit of U.S. Provisional Application No. 61/948,803 filed on Mar. 6, 2014. The above identified patent application is herein incorporated by reference in its entirety to provide continuity of disclosure.

### FIELD OF THE INVENTION

The present invention relates to photovoltaics and teaching aids. More specifically, the present invention relates to devices adapted to assist in teaching students the principles of photovoltaics by providing them with a convenient means to measure power generated by solar panels and the real world applications thereof. Additionally, the present invention is adapted to serve as a backup generator in emergency situations.

### BACKGROUND OF THE INVENTION

Science, technology, engineering, and mathematics (STEM) education has increasingly become a cornerstone of students' educations because of its importance in an increasingly technologically-dependent society. Furthermore, it is critical to educate students as to renewable sources of energy to encourage the next generations of STEM students to pursue these avenues of research. Access to hands-on activities and demonstrations generally increases the effectiveness of teachers' lesson plans; however, currently available photovoltaic devices are not adequate for serving as teaching aids because they do not allow individuals to monitor to the output of the solar panels, they are not adapted to allow users to easily adjust variables associated with the operation of the devices in order to test hypotheses, they are not generally transportable, and they lack the ability to provide users with the ability to visualize tangible, immediate effects of photovoltaics. Therefore, there is a need in the prior art for a teaching aid for photovoltaic concepts that provides all of the aforementioned benefits.

### SUMMARY OF THE INVENTION

In view of the foregoing disadvantages inherent in the known types of photovoltaic devices now present in the prior art, the present invention provides a photovoltaics teaching aid wherein the same can be utilized for providing convenience for the user when teaching students about clean energy. The present device is adapted to serve as a teaching aid in order to assist individuals in learning the principles behind photovoltaics, in order to better promote science, technology, engineering, and mathematics (STEM) education. The present invention comprises a transportable cart, an array of solar cells adjustably attached to the cart, a rechargeable battery, and a solar water heating system. The present invention further includes a number of different devices that are removably attached to the cart to assist individuals in making necessary measurements for calculations, including a multimeter and an angle gauge. Furthermore, a bus is provided that allows individuals to alternatively connect the panels of the solar array in series or in parallel. By changing the manner by which the panels are connected, individuals can study the different resulting effects on the other electrical components.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2 shows a perspective view of the control panel of the present invention.

FIG. 3 shows a perspective view of the present invention with the solar panels removed therefrom, exposing the solar water heating panel disposed thereunder.

FIG. 4 shows a schematic diagram of the water heating system of the present invention.

FIG. 5 shows a block diagram of the electrical components of the present invention.

### DETAILED DESCRIPTION OF THE INVENTION

Reference is made herein to the attached drawings. Like reference numerals are used throughout the drawings to depict like or similar elements of the photovoltaics teaching aid. For the purposes of presenting a brief and clear description of the present invention, the preferred embodiment will be discussed as used for teaching the students about clean energy. The figures are intended for representative purposes only and should not be considered to be limiting in any respect.

The present invention is a compact, portable device for use in assisting in teaching students the concepts, processes, and applications of photovoltaics, especially with regards to STEM education. The present invention is adapted to serve as a modular, adaptable device that can be used in many different ways to illustrate the principles and real-world applications of photovoltaics. The present invention comprises two separate systems demonstrating two separate applications of photovoltaics to the field of clean energy. The first system comprises a photovoltaic array that charges a battery disposed on the device and a number of different instruments that can be used in conjunction with this system to perform experiments with the charging of the battery. The second system comprises a solar water heating system that heats a volume of water held within a reservoir disposed on the cart that can be used to demonstrate to students the practicality and benefits of such heating systems.

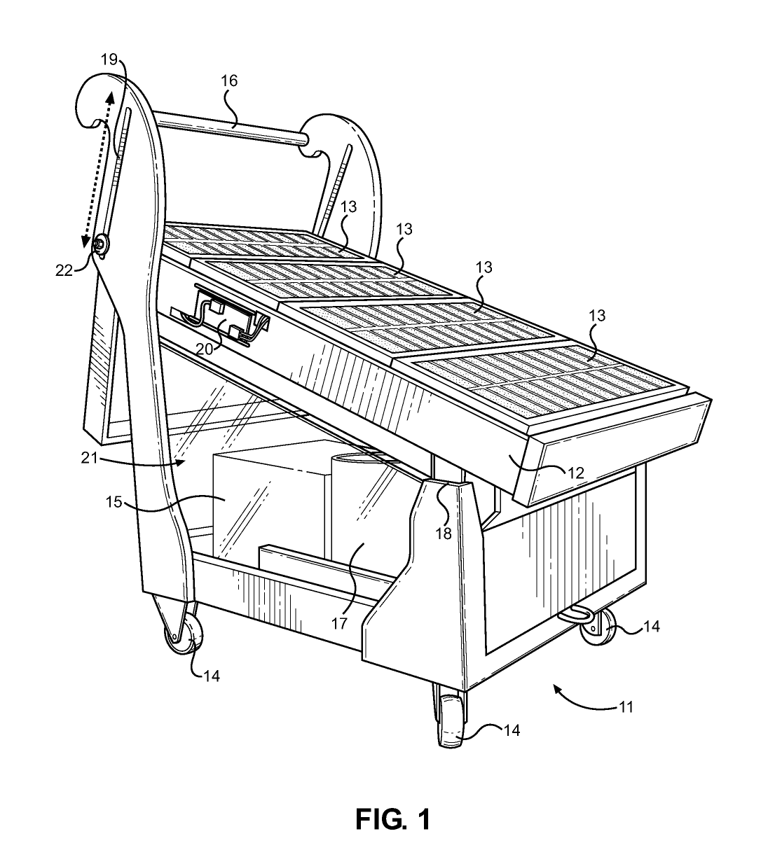

Referring now to FIG. 1, there is shown a perspective view of the present invention. The present invention comprises a cart 11 having a plurality of wheels 14 disposed on the undersurface thereof, a control panel 31, a support surface 12 with a photovoltaic array comprising one or more solar panels 13 disposed thereon, a storage area 21 disposed beneath the support surface 12, and a rechargeable battery 15. The support surface 12 is attached to the cart 11 via a pivotable connection 18 at a first end and via a slidable connection 19 at a second end thereof. The depicted embodiment of the present invention comprises four solar panels 13; however, no claim is made as to the number of solar panels 13 utilized by the present invention. The pivotable connection 18 allows uses to adjust the angle of the support surface 12 in order to, for example, compensate for the position of the sun in the sky and maximize the amount of solar energy to which the solar panels 13 are exposed. In the one embodiment of the present invention, the slidable connection 19 further comprises a locking mechanism adapted to hold the support surface 12 securely in place. In the depicted embodiment of the present invention, the locking mechanism comprises fasteners 22 with a nut. When the user wishes to adjust the position of the support surface 12, the user can loosen the fasteners 22, raise or lower the support surface to the desired angle, and then re-tightened the fasteners 22 to hold the support surface 12 at the desired angle. However, no claim is made as to the specific type of locking mechanism utilized by the present invention. The solar panels 13 comprise conventional solar panels as are known in the prior art.

The solar panels 13 are connected to the various other electrical components of the present invention via a bus 20. The solar panels 13 are in turn removably connected to the bus 20 via electrical connectors, such as banana clips. The solar panels 13 can be connected either in parallel or in series by altering the manner in which the solar panels' 13 electrical connectors are connected to the bus 20. This allows students to test the differences between electrical circuitry connected in series or in parallel and run experiments using circuits of these different configurations.

The solar panels 13 are in electrical communication, through the bus 20, with at least one rechargeable battery 15 disposed on the cart 11. As with conventional photovoltaic arrays, the solar panels 13 convert solar energy to DC electricity, which is then stored for later use by the battery 15. In one embodiment of the present invention, the solar panels 13 are electrically coupled to an inverter, which is then in turn electrically coupled to the battery 15. In one embodiment, the inverter comprises a solar inverter, which compensates for the variable magnitude of the DC electricity generated by the solar panels 13.

The cart 11 comprises a handle 16 and a plurality of wheels 14 disposed on the undersurface thereof to provide mobility for the present invention. The mobility of the present invention allows the cart 11 to be moved between outdoor demonstrations, wherein the solar panels 13 can be charged via solar energy, to indoor demonstrations in which the energy that has been stored in the power source 15 can then be used to power various devices, demonstrating to individuals the benefits of clean energy. The cart 11 further comprises a storage area 21 beneath the support surface 12 for storing the various electrical components of the present invention. In the depicted embodiment of the present invention, the battery 15 and the reservoir 17 of the solar water heating system are held within the storage area 21; however, no claim is made as to the precise location of these components. The storage area 21 preferably further comprises one or more sidewalls extending therearound, preventing the contents of the storage area 21 from falling from the cart 11 during transport or being stolen therefrom if the cart 11 is left unattended. In one embodiment of the present invention, the sidewalls are constructed from poly(methyl methacrylate).

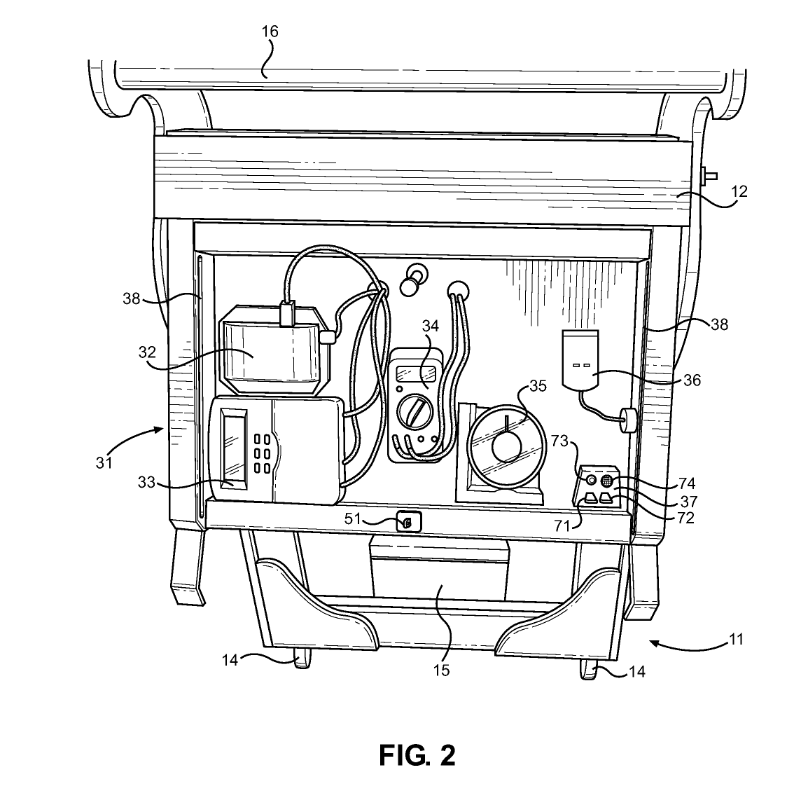

Referring now to FIG. 2, there is shown a perspective view of the control panel of the present invention. The control panel 31 comprises a number of different electronic components or measurement devices that are used in conjunction with the systems of the present invention to run experiments and record data. The control panel 31 comprises an inverter 32, a temperature control unit 33, a multimeter 34, an angle gauge 35, a charge controller 36, and a notification device 37. In one embodiment of the present invention, the multimeter 34 is removably attached to the control panel via hook-and-loop fastening material or another such connector. In this embodiment, users can remove the multimeter 34 from the control panel 31 and test the electrical connections between the various electrical components of the present, such as the electrical connection between the solar panels and the bus to determine the amount of electrical energy being generated by the photovoltaic array. The angle gauge 35 indicates the angle at which the support surface 12 is disposed. This can be used by users to set the photovoltaic array at precise positions to either compensate for the changing position of the sun in the sky in order to maximize the amount of solar energy that impinges upon the photovoltaic array or run tests to determine the change in the amount of electrical energy generated by the solar cells as a function of the offset angle between the photovoltaic array and the sun.

The inverter 32 comprises a conventional DC-AC inverter. The inverter 32 is electrically coupled to the battery and an output, which can in turn be connected to various loads or electronic devices not associated with the present invention. Therefore, after charging the battery using the photovoltaic array, users are then able to demonstrate that the battery has been charged by connecting external electronic devices, such as a television, to the battery and powering those electronic devices solely off of the solar-charged battery.

The temperature control unit 33 is connected to the solar water heating system and indicates or displays the temperature of the water within the reservoir. When the temperature of the water reaches the desired temperature, the users can then choose to shut off the system to prevent overheating of the water. In an alternative embodiment, the temperature control unit 33 further comprises a safety shutoff that automatically deactivates the water pump when the temperature of the water has reached a pre-programmed value, thereby preventing water from being circulated through the solar water heating system and further heated beyond this value.

The present invention further comprises a conventional charge controller 36, which limits the rate at which current is supplied to or withdrawn from the battery in order to ensure the battery life of the battery is properly maintained. The charge controller 36 is useful because the photovoltaic array is a DC power source having a variable electrical output since the output is dependent upon environmental conditions, such as the degree of cloud cover, and other variables, such as the angle of the support surface 12 relative to the sun. The charge controller 36 protects against overvoltage and the damage to batteries that results therefrom.

The present invention further comprises a notification device 37 disposed on the control panel 31. The notification device 37 is adapted to indicate to users if the battery is being charged by the photovoltaic array and the magnitude of the electrical energy being generated by the photovoltaic array. The notification device 37 comprises a charge indicator 73, which is activated by a first switch 71, and an output indicator 74, which is activated by a second switch 71. In an exemplary embodiment of the present invention, the charge indicator 73 comprises a light that is activated when both the battery is receiving electrical energy from the photovoltaic array, i.e. being charged, and the first switch 71 has been actuated. This allows individuals to determine if there is an issue with the electrical connections between the photovoltaic array and the battery or if cloud cover is too substantial for the photovoltaic array to generate electricity. In an exemplary embodiment of the present invention, the output indicator 74 comprises a sound-generating device that emits an audible alert when the battery is being charged, wherein the rate at which the audible alerts are generated is proportional to the magnitude of the electrical energy being received by the battery. This allows users to ascertain the ideal positioning of the present invention, such as the physical location of the cart 11 and the angle of the support surface 12 relative to the sun, to maximize the amount of electrical energy generated by the solar panels.

An alternative embodiment of the present invention further comprises a lock 51 for locking a cover (not shown) over the control panel 31. A cover is slidably insertable along the slots 38 disposed on the sides of the control panel 31. When the cover is in place, it covers the control panel 31 and prevents access to the various components thereunder. The cover has a size and shape conforming to the size and shape of the control panel 31, allowing the cover to prevent access to the instrumentation therebelow when in place. Once the cover is secured in place along the slots 38, the lock 51 can then be engaged to prevent the cover from being withdrawn from the control panel 31. In the depicted embodiment of the present invention, the lock 51 comprises a U-shaped member to which a conventional padlock can be applied to secure the cover in place. The cover is preferably constructed from a durable, impact-resistant material, such as poly(methyl methacrylate).

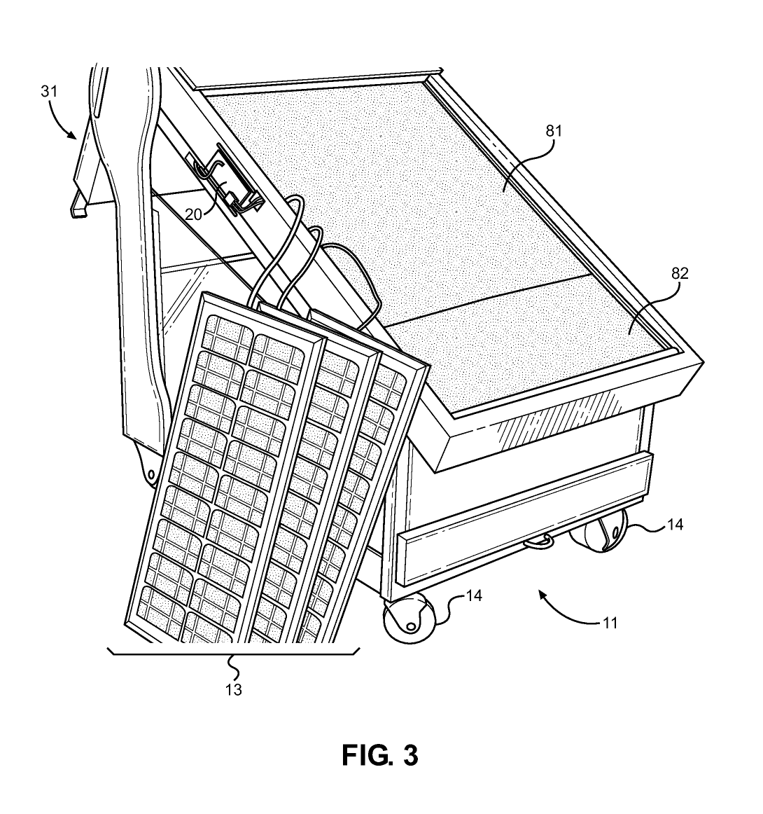

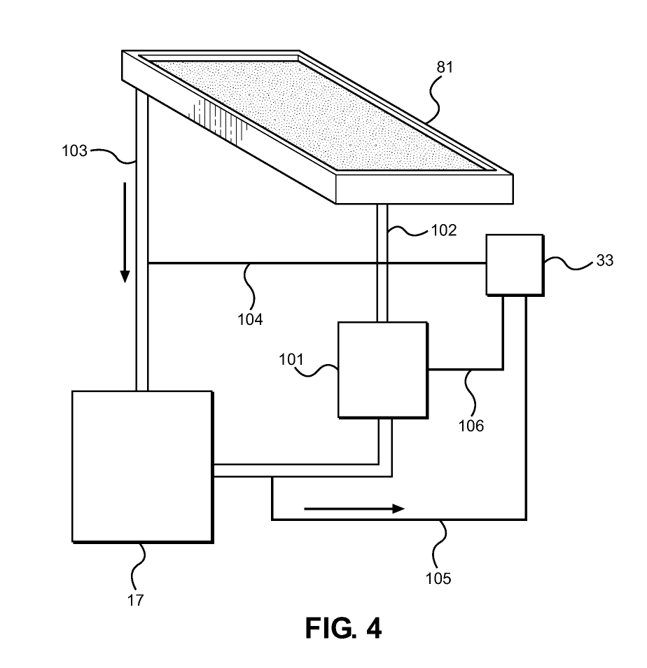

Referring now to FIGS. 3 and 4, there are shown a perspective view of the present invention with the solar panels removed therefrom, exposing the solar water heating panel disposed thereunder, and a schematic diagram of the water heating system of the present invention. The solar panels 13 are removably attached to the support surface 12, over a solar water panel 81. The solar panels 13 are removably connected to the support surface 12 via any means known in the prior art. When the solar panels 13 are removed from the support surface 12, the solar water panel 81 thereunder is exposed and the solar water heating system can be activated.

The solar water heating system comprises the water heating panel 81 disposed on the top surface of the support surface 12, a water reservoir 17 disposed within the storage area beneath the support surface 12, and a pump 101. The pump 101 comprises a DC pump. The reservoir 17 comprises an outlet 102 that is connected to a first end of the water heating panel 81 and an inlet 103 that is connected to a second end of the water heating panel 81. When the pump 101 of the solar water heating system is activated, it draws water 82 from the reservoir 17 and supplies it to the water heating panel 81. The water 82 is then driven through the water heating panel, exposing the water 82 to the sun. As the water 82 is exposed to the sun, it is heated thereby. The water heating panel 81 comprises a transparent upper surface, an insulative lower surface, and an interior volume therebetween through which the water 82 is pumped. The large surface area of the water heating panel 81 maximizes the amount of solar energy to which the water 82 is exposed, which assists in heating the water 82 more quickly. Once driven through the water heating panel 81, the water 82 is returned to the reservoir 17 and re-circulated through the system continuously until the water 82 is heated to a desired temperature. Once heated to the desire temperature, the system can be deactivated and then the water 82 can be removed from the reservoir 17 as desired by the user.

An alternative embodiment of the present invention further comprises a temperature control unit 33 that controls the operation of the solar water heating system. The temperature control unit 33 comprises a first connection 104 to the inlet 103 and a second connection 105 to the outlet 102. Using the first and second connections 104, 105 the temperature control unit 33 is adapted to measure the temperature of the water at various points in the system. Furthermore, the temperature control unit 33 is adapted to measure the temperature difference between the water entering the reservoir 17 and the water exiting the reservoir. If the temperature differential reaches unsafe levels, the temperature control unit 33 can automatically deactivate the pump 101 via an electrical connection 106 thereto.

Although the depicted embodiment of the present invention is an active solar water heating system, no claim is made as to the specific type of solar water heating system utilized by the present invention. The present disclosure also contemplates the use of passive solar water heating systems as are conventionally known in the prior art. Furthermore, no claim is made as to the means by which the solar water heating system is activated. In one embodiment of the present invention, the solar water heating system comprises a sensor that detects the removal of the solar panels 13 from the support surface 12 and automatically activates the system in response thereto. In another embodiment of the present invention, the solar water heating system is activated by the user.

In exemplary embodiments of the present invention, the power source for the pump 101 comprises one of the solar panels 13 or the internal rechargeable battery. In the former embodiment, the pump 101 is in electrical communication with one or more of the solar panels 13 and is powered thereby. In this embodiment of the present invention, the user removes all of the solar panels 13, except for one solar panel 13, which is left in place to power the pump 101. Alternatively, the user can choose to leave more than one of the solar panels 13 in place to power the pump 101; however, this sacrifices surface area of the water heating panel 81. In the latter embodiment, the pump 101 is powered by the integral battery, which was in turn previously charged by the solar panels. The latter embodiment of the present invention is suitable for simulation purposes for demonstrating the function of the solar hot water heating system to students in an indoor environment or if there is insufficient solar energy available to power the pump 101.

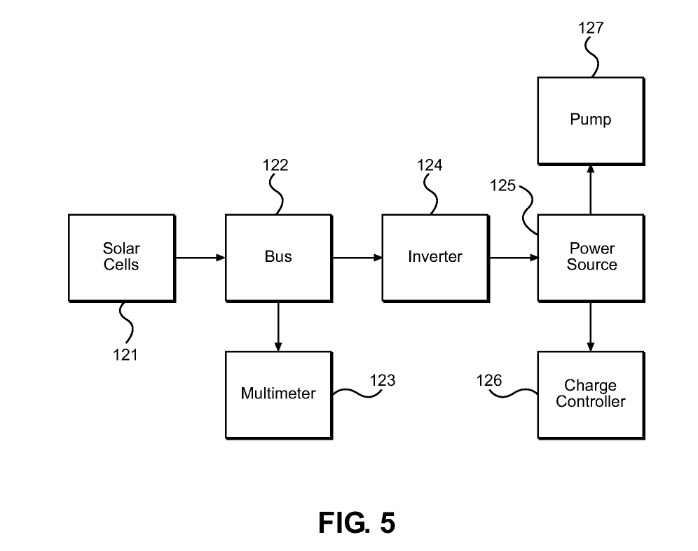

Referring now to FIG. 5, there is shown a block diagram of the electrical components of the present invention. The solar cells 121 are connected to the other electrical components of the present invention via the bus 122, which allows users to change manner in which the solar panels are connected, i.e. in series or in parallel. The multimeter 123 provided with the invention is adapted to measure the voltage, current, and other such variables at the bus 122 to determine the amount of electrical energy being generated by the solar cells 121. In one embodiment of the present invention, the bus 122 is then connected to the power source 125 by an inverter 124, such as a solar inverter that compensates for the variable magnitude of the DC electricity generated by the solar panels. The current supplied to the power source 125, i.e. the rechargeable battery, is limited by a charge controller 126. Then in one embodiment of the present invention, the power source 125 supplies the energy for the pump 127 of the solar hot water heating system, as discussed above. In an alternative embodiment of the present invention, the pump 127 is supplied electrical energy via one or more of the solar panels, rather than the battery.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A photovoltaic teaching aid, comprising:
a cart comprising a support surface pivotably attached thereto;
a battery disposed on the housing;
a plurality of solar panels removably attached to the support surface;
wherein the plurality of solar panels are interchangeably connectable in series or in parallel;
a solar water heating system comprising a water panel disposed on the support surface beneath the plurality of solar panels and a water reservoir disposed on the cart;
wherein water is circulated through the water reservoir and the water panel when the solar water heating system is activated;
wherein the plurality of solar panels are in electrical communication with the battery.

2. The photovoltaic teaching aid of claim 1, wherein the solar water heating system further comprises a pump adapted drive water through the system.

3. The photovoltaic teaching aid of claim 1, further comprising a multimeter removably attached to a control panel.

4. The photovoltaic teaching aid of claim 1, further comprising an angle gauge adapted to indicate an angle at which the support surface is positioned.

5. The photovoltaic teaching aid of claim 1, further comprising:
a charge indicator in electrical communication with the battery;
wherein the charge indicator is activated when the battery is charging.

6. The photovoltaic teaching aid of claim 5, wherein the charge indicator comprises a light.

7. The photovoltaic teaching aid of claim 1, further comprising:
an output indicator in electrical communication with the battery;
wherein the output indicator emits an audible alert at a rate proportional to a magnitude of electrical energy received by the battery.

8. The photovoltaic teaching aid of claim 1, wherein the solar hot water system further comprises a power source in electrical communication with the pump.

9. The photovoltaic teaching aid of claim 8, wherein the power source comprises the battery.

10. The photovoltaic teaching aid of claim 8, wherein the power source comprises one or more of the plurality of solar panels.

11. The photovoltaic teaching aid of claim 10, wherein the power source is non-removable from the support surface.
